(19) United States
(12) Patent Application Publication
(10) Pub. No.: US 2008/0098178 A1
(43) Pub. Date: Apr. 24, 2008

(54) DATA STORAGE ON A SWITCHING SYSTEM COUPLING MULTIPLE PROCESSORS OF A COMPUTER SYSTEM

(76) Inventors: Judson E. Veazey, Ft. Collins, CO (US); Donna E. Ott, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/551,777

(22) Filed: Oct. 23, 2006

(51) Int. Cl. G06F 12/00

(52) U.S. Cl. 711/147

(57) ABSTRACT

A computing system is provided which includes a number of processing units, and a switching system coupled with each of the processing units. The switching system includes a memory. Each of the processing units is configured to access data from another of the processing units through the switching system. The switching system is configured to store a copy of the data passing therethrough into the memory as the data passes between the processing units though the switching system. Each of the processing units is also configured to access the copy of the data in the memory of the switching system.

### BACKGROUND

Computing systems come in many varieties, such as general-purpose computing systems or algorithmic devices, intended for more specific tasks. However, along with cost, one of the most important characteristics of any computer system is its performance. Performance, or execution speed, is often quantified in terms of a number of operations the system may execute during a particular time period. The performance of typical computer systems employing a single primary processing unit has consistently increased over many years, due to a number of factors. For example, improvements in the raw operating speed of various system components, such as the processing unit itself, data memory, input/output (I/O) peripherals, and other portions of the system, have contributed to the increased performance. In addition, advances in the internal structure of the processing unit, including the instruction set employed, the number of internal data registers incorporated, and so on, have enhanced computer performance. Other architectural concerns, such as the use of a hierarchical data storage system employing one or more cache memories for often-accessed data, have contributed to these performance improvements as well.

To produce greater enhancements in computer execution speed beyond the single-processor model, numerous multiprocessor computing system architectures, in which multiple processing units are coupled together to work in some cooperative fashion, have been proposed and implemented. To perform some common task, the processing units normally intercommunicate by way of sharing some type of information therebetween, thus allowing the processing units to coordinate their activities. Many of these devised architectures implement the sharing of data, along with execution control and status information, between the processing units by way of a common memory address space.

Normally, an objective of a multiprocessing computer system is an extreme reduction of the execution time for a particular task over a single-processor computer. This reduction approaches a theoretical limit of a factor equal to the number of processing units employed. Unfortunately, problems not encountered in single-processor systems, such as contention between the multiple processing units for the same portion of a shared address space, can slow down the execution of one or more of the processing units, thereby inhibiting the performance increases obtainable.

To address this problem, some computing systems allow multiple copies of the same data to exist within the system so that any contention for access to the same data between processing units may alleviated. However, as each of the processing units may alter one or more of the data copies present within the system, coherence, or consistency, of the data may be compromised without some rules regarding the existence of the copies and restrictions on modification of that data. These rules, in turn, tend to reduce the effectiveness of allowing multiple copies of the data.

### BRIEF DESCRIPTION OF THE DRAWINGS

FIG. 1 is a block diagram of a computing system according to an embodiment of the invention.

FIG. 2 is a flow diagram of a method for operating a computing system according to an embodiment of the invention.

FIG. 3 is a block diagram of a computing system according to another embodiment of the invention.

FIG. 4 is a block diagram of a processing unit of the computing system of FIG. 3 according to another embodiment of the invention.

FIG. 5 is a flow diagram of a method for operating the computing system of FIGS. 3 and 4 according to an embodiment of the invention.

### DETAILED DESCRIPTION

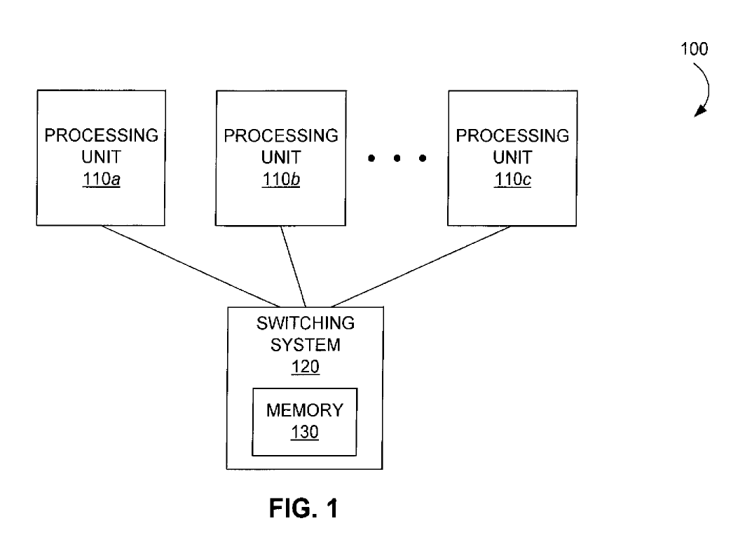

One embodiment of the invention is a computing system 100 as shown in FIG. 1. Included in the computing system 100 is a plurality of processing units 100a, 100b, 100c. While at least three processing units are shown in FIG. 1, a minimum of two may be employed in other embodiments. Coupled with each processing unit 110 is a switching system 120, which includes a memory 130. Each of the processing units 110 is configured to access data from another of the processing units 110 through the switching system 120. The switching system 120 is configured to store a copy of the data into the memory 130 as the data passes between the processing units 110 through the switching system 120. Further, each of the processing units 110 is further configured to access the copy of the data in the memory 130 of the switching system 120.

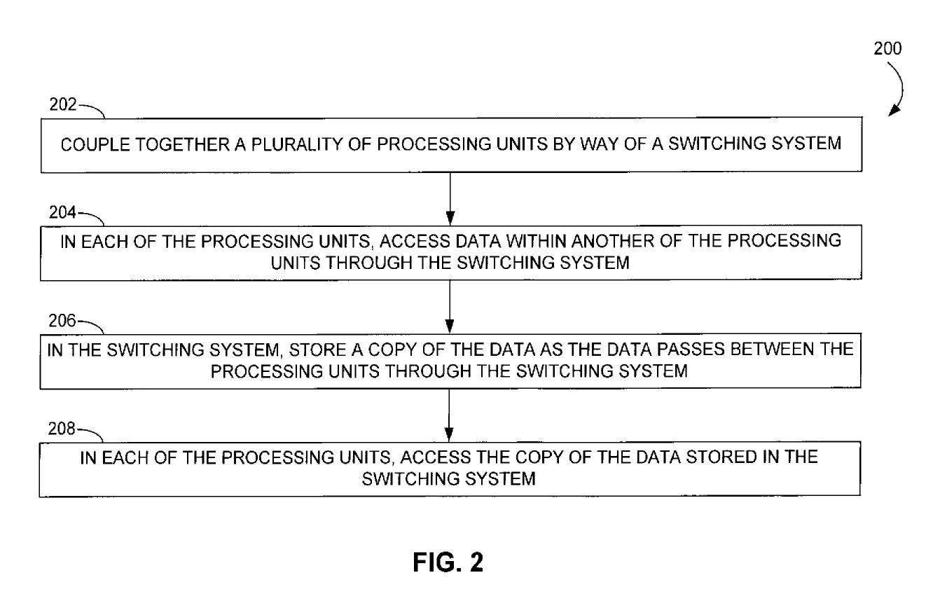

FIG. 2 illustrates by flow diagram a method 200 of operating a computing system, such as the system 100 of FIG. 1. However, other systems may be employed for performing the method 200 in other embodiments. First, a plurality of processing units is coupled together by way of a switching system (operation 202). In each of the processing units, data is accessed within another of the processing units through the switching system (operation 204). In the switching system, a copy of the data is stored as the data passes between the processing units through the switching system (operation 206). Further, in each of the processing units, the copy of the data stored in the switching system is accessed (operation 208).

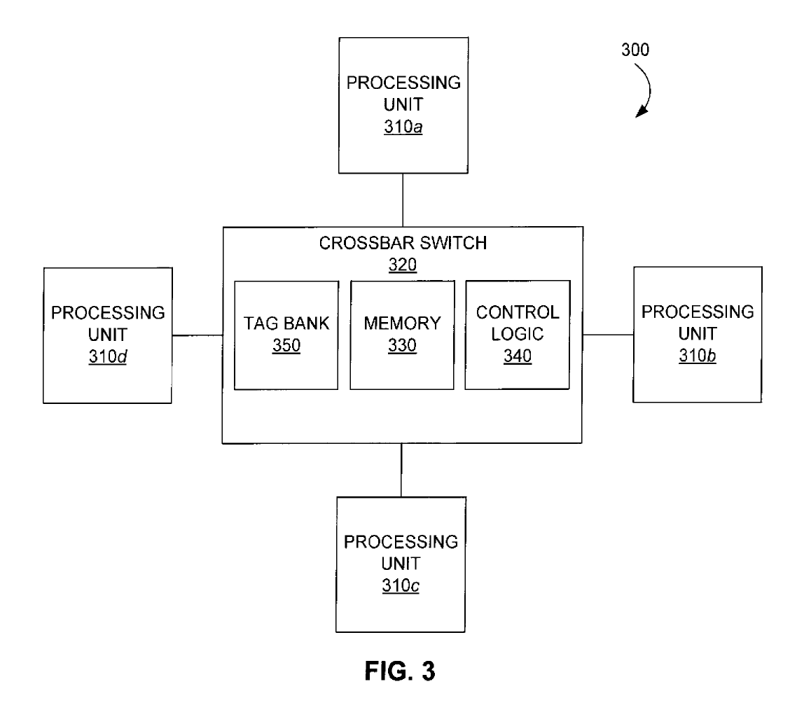

FIG. 3 depicts a particular computing system 300 according to another embodiment of the invention. While the computing system 300 is described below in specific terms, such as the number of processing units, the type of switching system employed to interconnect the processing units, and so on, other embodiments employing variations of the details specified below are also possible.

The computing system 300 includes four processing units 310a, 310b, 310c, 310d. Each of the processing units is coupled to a crossbar switch 320. Incorporated within, or coupled directly with, the crossbar switch 320 is a memory 330. Also residing within the switch 320 is control logic 340 and a tag bank 350, whose functionality is described below. A system architecture employing multiple processing units and a switch as shown in FIG. 3 is often called a “symmetric multiprocessing,” or SMP, system. This term is commonly applied to computing systems employing any number of multiple identical processing units which share a common memory address space. SMP architectures are commonly used in UNIX and NT/2000 computing systems. While FIG. 3 specifically indicates the presence of four processing units 310, more processing units 310, or as few as two processing units 310, may be utilized in other embodiments.

The crossbar switch 320 acts as a switching system configured to allow communication, such as transference of data, between any two of the processing units 310. Further, communication between any of the processing units 310 may occur concurrently through the crossbar switch 320. Other information, such as status and control information, inter-processor messages, and the like, may be passed through the switch 320 between the processing units 310 in other implementations. In still other embodiments, switches other than crossbar switches which facilitate the passing of data between the processing units 310 may be utilized. In another implementation, more than one switch 320, one or more of which contains a memory 330, may be utilized and configured to form a switching system or “fabric” inter-coupling the various processing units 310. Under this scenario, the memory 330 may be distributed among two or more of the switches forming the switching fabric or system.

The memory 330 of the crossbar switch 320 may be any memory capable of storing some portion of data passing through the switch 320 between the processing units 310. In one implementation, the storage capacity of the memory 320 is at least one gigabyte (GB). Any of a number of memory technologies may be utilized for the memory 320, including, but not limited to, dynamic random access memory (DRAM) and static random access memory (SRAM), as well as single in-line memory modules (SIMMs) and dual in-line memory modules (DIMMs) employing either DRAMs or SRAMs.

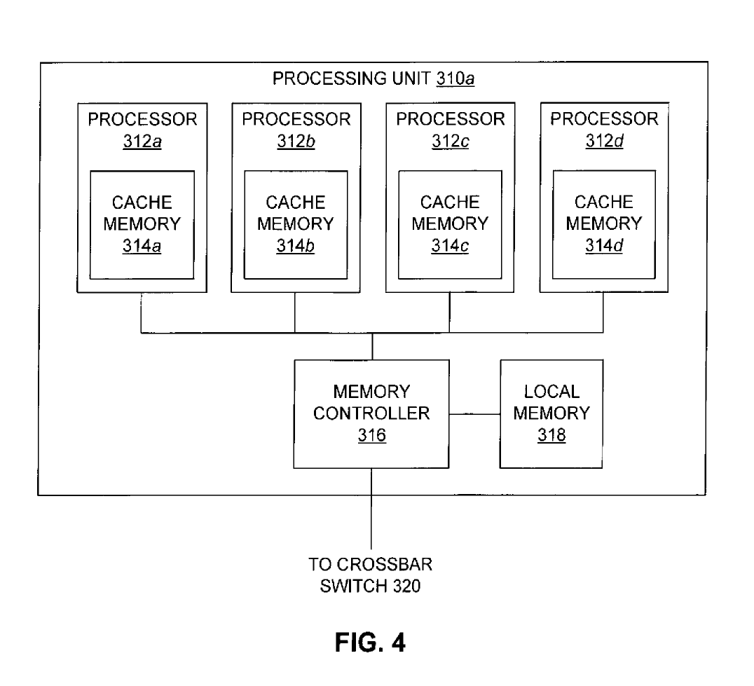

A more detailed representation of one of the processing units 310a is presented in the block diagram of FIG. 4. Any or all of the other processing units 310 of FIG. 3 may display the same architecture, or may employ an entirely different internal structure. In FIG. 4, the processing unit 310a includes four processors 312a, 312b, 312c, 312d, each of which in turn includes cache memory 314a, 314b, 314c, 314d, respectively. Further, each of the processors 312 is coupled to a memory controller 316. The memory controller 316, in turn, is coupled to each of a local memory 318 located within, or closely coupled with, the processing unit 310a, and with the crossbar switch 320 displayed in FIG. 3. In other embodiments, each processing unit 310 may have one or more processors 312.

Generally, each of the processing units 310 of the particular system 300 of FIG. 3 accesses the same shared memory address space. The shared address space is distributed or allocated among some or all of the local memories 318 of the processing units 310. In one implementation, the local memory 318 of each processing unit 310 contains the data associated with an exclusive portion of the memory address space shared by the processing units 310. For that portion of the address space, the associated processing unit 310 may be considered the “home” location for that data, from which the other processing units 310 may access that data through the switch 320. In some cases, the most recent version of a requested portion of data may not be located at the home processing unit 310, but at another processing unit 310. However, in such an embodiment, the home processing unit 310 and/or the switch 320 holds information in a directory or similar data structure indicating the location of the most recent version of the data. In another embodiment, each of the processing units 310 may also utilize its local memory 318 as a cache for data homed at, and previously accessed from, another processing unit 310. Thus, for any particular data accessed by one of the processing units 310 within that shared address space, the data may reside within the processing unit 310 requesting the data, or within another of the processing units 310, or both. In addition, each of the processing units 310 may have access to data memory reserved for its own use, which is not explicitly shown in FIG. 4.

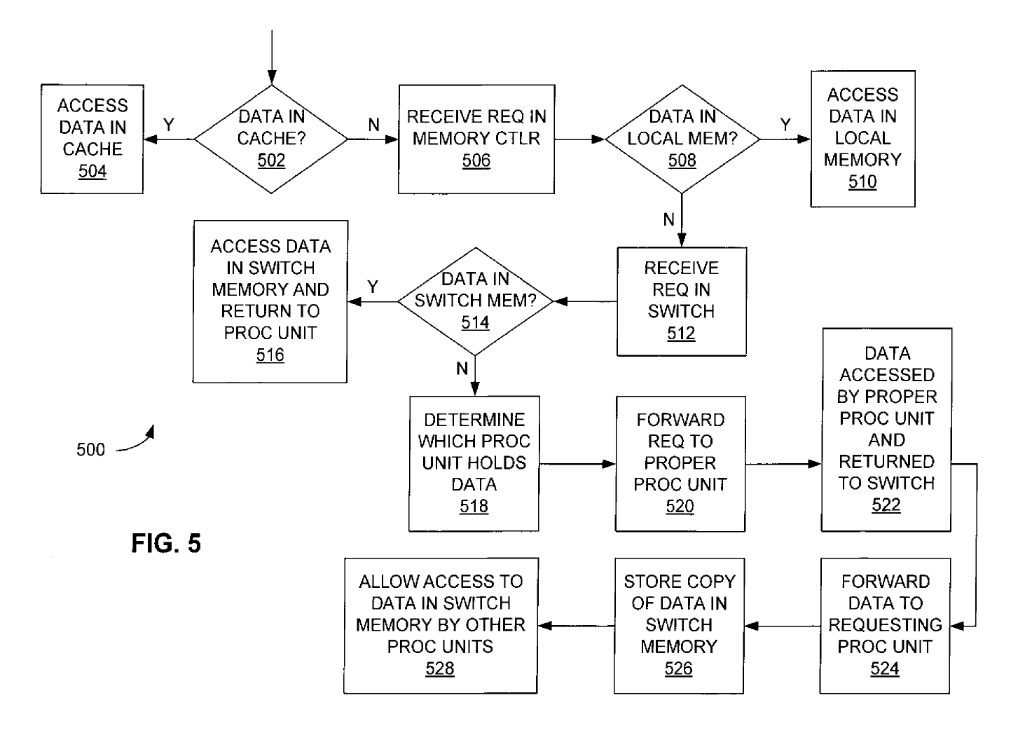

FIG. 5 depicts a high-level view of a method 500 for operating the system 300 of FIG. 3. With respect to the processing unit 310a illustrated in FIG. 4, each processor 312, when accessing (e.g., reading) a particular datum within the shared memory space, may first search its own cache memory 314 (operation 502). If found in the cache 314, the data is accessed (operation 504). Otherwise, the memory controller 316 receives the data request from the processor 312 (operation 506). In response, the memory controller 316 may first search the local memory 318 of the processing unit 310 (operation 508). If the search for the requested data in the local memory 318 is successful, the data is accessed and returned to the processor 312 (operation 510); otherwise, the request may then be forwarded to the crossbar switch 320 (operation 512).

After the crossbar switch 320 receives a memory request from the processing unit 310a, the switch 320 may search its memory 330 for the requested data (operation 514). If the data is stored in the memory 330, the data is accessed and returned to the requesting processing unit 310 (operation 516). If not found, the switch 320 may determine which of the remaining processing units 310 possesses the data (operation 518), such as the particular processing unit 310 acting as the home location for the requested data, and direct the request thereto (operation 520). The processing unit 310 receiving the request accesses the requested data and returns it to the switch 320 (operation 522), which in turn forwards the requested data to the requesting processing unit 310 (operation 524). In addition, the switch 320 may also store a copy of the data being returned to the requesting processing unit 310 within its memory 330 (operation 526). Any of the processing units 310 may then access the copy of the data stored within the memory 330 (operation 528).

In the case in which the most recent version of the requested data is not located at the home processing unit 310, the home unit 310 may forward the request by way of the switch 320 to the particular processing unit 310 holding the most recent version of the requested data. In another implementation, the switch 320 may forward that request directly without involving the home unit 310. The unit 310 holding the most recent version may then return the requested data to the switch 320, which may then pass the data directly to the requesting unit 310. In a further embodiment, the switch 320 may also forward the most recent version to the home unit 310, which may then update its copy of the data.

In embodiments in which more than one switch 320 is employed within the computing system 300, more than one of the switches 320 may be involved in transferring data requests and responses between the various processing units 310. For example, upon receipt of a request for data from one of the processing units 310, one of the switches 320 may forward the request to another processing unit 310, either directly or by way of another switch 320. Data returned by a processing unit 310 in response to such a request may be returned to the requesting processing unit 310 in a similar manner. Further, one or more of the switches 320 through which the data passes may store a copy of that data for later retrieval by another processing unit 310 subsequently requesting that data.

Given that the single shared memory space is distributed among the several processing units 310, and also that each processing unit 310 may cache temporary copies of the data within its associated cache memories 314 or its local memory 318, a potential cache coherence problem may result. In other words, multiple copies of the same data, each exhibiting potentially different values, may exist. For example, if one processing unit 310 accesses data stored within the local memory 318 of another processing unit 310 through the switch 320, a question exists as to whether that data will ultimately be cached in the requesting processing unit 310, such as within one of the cache memories 314 or the local memory 318 of the processing unit 310a. Caching the data locally results in multiple copies of the data within the system 300. Saving a copy of the data within the memory 330 of the switch 320 also potentially raises the same issue.

To address possible cache coherency problems, the switch 320 may select which of the data passing through the switch 320 between the processing units 310 are stored within the memory 330. In one embodiment, such a selection may depend upon information received by the switch 320 from the processing unit 310 requesting the data. For example, the data requested may be accessed under one of two different modes: exclusive mode and shared mode. In shared mode, the requesting processing unit 310 indicates that it will not be altering the value of the data after it has been read. Oppositely, requesting access to data under exclusive mode indicates that the processing unit 310 intends to alter the value of the data being requested. As a result, multiple copies of that specific data being accessed under shared mode will all have the same consistent value, while a copy data being acquired under exclusive mode is likely to be changed, thus causing other copies of that same data to become invalid.

In one embodiment employing these two modes, the switch 320 may store data requested in shared mode in memory 330, if enough space exists within the memory 330. On the other hand, data passing through the switch 320 which is being accessed under exclusive mode will not be stored in the memory 330. Accordingly, data within the memory 330 of the switch 320 used to satisfy further data requests from one or more processing units 310 are protected from being invalidated due to alteration by another processing unit 310.

By storing at least some of the data passing through the switch 320 within the memory 330, the switch 320 may satisfy subsequent requests for that same data by reading the data directly from the memory 330 and transferring the data to the requesting processing unit 310. Otherwise, the request would be forwarded to the processing unit 310 possessing the data, after which the processing unit 310 servicing the request would read the data from its own local memory 318 and transfer the data to the switch 320, as described above. Only then would the switch 320 be capable of transferring the data to the requesting processing unit 310. Thus, in situations in which the memory 330 contains the requested data, latency between a data request and satisfaction of that request is reduced significantly. Also, overall traffic levels between the processing units 310 and the switch 320 are lessened significantly as a result due to the fewer number of data requests being forwarded to other processing units 310, thus enhancing the system 310 throughput and performance.

Presuming a finite amount of data storage available in the memory 330 of the switch 320, the memory 330 is likely to become full at some point, thus requiring some determination as to which of the data stored in the memory 330 is to be replaced with new data. To address this concern in one embodiment, the switch 320 may replace the data already stored in the memory 330 under at least one cache replacement policy. For example, the switch 320 may adopt a least-recently-used (LRU) policy, in which data in the memory 330 which has been least recently accessed is replaced with the newest data to be stored into the memory 330. In another implementation, the switch 320 may utilize a not-recently-used (NRU) policy, in which data within the memory 330 which has not been recently accessed within a predetermined period of time is randomly selected for replacement with the new data. Other cache replacement policies, including, but not limited to, first-in-first-out (FIFO), second chance, and not-frequently-used (NFU), may be utilized in other embodiments.

As described in some embodiments above, the memory 330 may be implemented as a kind of cache memory. As a result, the memory 330 may be designed in a fashion similar to an external cache memory, such as a level-4 (L4) cache sometimes incorporated in central processing unit (CPU) computer boards.

In one embodiment, the switch 320 employs control logic 340 which analyzes each request for data received from the processing units 310 to determine to which of the processing units 310 the request is to be directed. This function may be performed in one example by comparing the address of the data to be accessed with a table listing addresses or address ranges of the shared address space associated with particular processing units 310. As part of this analysis, the control logic 340 may also compare the address of the requested data with a “tag bank” 350 that includes information regarding whether the data is located in the memory 330, and, if so, the location of that data within the memory 330. In one example, a non-sequential tag look-up scheme is implemented to reduce the time required to search the tag bank 350 for information regarding the requested data.

To reduce the amount of information required in the tag bank 350, the shared memory area and, consequently, the memory 330 of the switch 320, may be organized in cache “lines.” with each line including data from multiple, contiguous address locations of the shared address space. Grouping locations of the address space in such a fashion allows a smaller tag bank 350 to be maintained and searched.

While several embodiments of the invention have been discussed herein, other embodiments encompassed by the scope of the invention are possible. For example, while specific embodiments of the invention described in conjunction with FIGS. 3 and 4 employ an SMP system with a single crossbar switch 320, other computing system architectures using multiple processors coupled with one or more switches or other interconnection devices configured as a switching system or fabric may benefit from the embodiments presented herein. In addition, aspects of one embodiment may be combined with those of other embodiments discussed herein to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. A computing system, comprising:
processing units; and
a switching system coupled with each of the processing units, wherein the switching system comprises a memory;
wherein each of the processing units is configured to access data from another of the processing units through the switching system;
wherein the switching system is configured to store a copy of the data into the memory as the data passes between the processing units through the switching system; and
wherein each of the processing units is further configured to access the copy of the data in the memory of the switching system.

2. The computing system of claim 1, wherein the switching system is configured to allow more than one pair of the processing units to transfer data therebetween simultaneously.

3. The computing system of claim 1, wherein the switching system further comprises a control circuit con figured to select which of the data passing between the processing units through the switching system is stored in the memory.

4. The computing system of claim 1, wherein the data passing between the processing units is read by one of the processing units in one of an exclusive mode and a shared mode;
wherein the data read in the exclusive mode is not stored in the memory; and
wherein the data read in the shared mode is stored in the memory.

5. The computing system of claim 1, wherein the data within the memory is replaced under a cache replacement policy.

6. The computing system of claim 5, wherein the cache replacement policy comprises at least one of a least-recently-used policy and a not-recently-used policy.

7. The computing system of claim 1, wherein at least one of the processing units comprises:
a first processor; and
a local memory coupled with the first processor;
wherein the first processor is configured to access the local memory.

8. The computing system of claim 7, wherein the at least one of the processing units further comprises:
a second processor, wherein the second processor is configured to access the local memory.

9. The computing system of claim 8, wherein:
the at least one of the processing units further comprises a memory controller coupling the local memory with the first processor and the second processor; and
the memory controller is configured to direct access requests received from the first processor and the second processor for data residing in the local memory to the local memory; and to direct other access requests received from the first processor and the second processor toward the switching system.

10. The computing system of claim 9, wherein:
the at least one of the processing units further comprises a first cache memory coupled with the first processor, and a second cache memory coupled with the second processor;
the first cache memory is configured to service access requests from the first processor for data residing in the first cache memory, and to forward access requests for data not residing in the first cache memory to the memory controller; and
the second cache memory is configured to service access requests from the second processor for data residing in the second cache memory, and to forward access requests for data not residing in the second cache memory to the memory controller.

11. A method of operating a computing system, comprising:
coupling together processing units of the computing system by way of a switching system of the computing system;
in each of the processing units, accessing data stored within another of the processing units through the switching system;
in the switching system, storing a copy of the data as the data passes between the processing units through the switching system; and
in each of the processing units, accessing the copy of the data stored in the switching system.

12. The method of claim 11, further comprising:
in each of the processing units, accessing data stored within the processing unit.

13. The method of claim 11, wherein each of the processing units may access the data stored within another of the processing units through the switching system simultaneously.

14. The method of claim 11, further comprising selecting which of the data passing between the processing units through the switching system is stored therein.

15. The method of claim 11, wherein:
accessing the data stored within another of the processing units is performed in one of an exclusive mode and a shared mode;
the data accessed in the exclusive mode is not stored in the switching system; and
the data accessed in the shared mode is stored in the switching system.

16. The method of claim 11, further comprising:
replacing the data within the switching system according to a cache replacement policy.

17. The method of claim 16, wherein the cache replacement policy comprises at least one of a least-recently-used policy and a not-recently-used policy.

18. The method of claim 11, wherein:
accessing data stored within another of the processing units through the switching system comprises directing access requests for data not residing within the processing unit toward the switching system.

19. A storage medium comprising instructions executable on a processor for employing the method of claim 11.

20. A computing system, comprising:
multiple means for processing data;
means for coupling together the multiple processing means for transfer of the data therebetween;
means for storing a copy of the data as the data passes between the multiple processing means through the coupling means; and
for each of the multiple processing means, means for accessing data, wherein the data may be stored within any other of the multiple processing means through the coupling means, and within the coupling means.
